(19) United States
(12) Patent Application Publication
(10) Pub. No.: US 2010/0212224 A1
(43) Pub. Date: Aug. 26, 2010

(54) SLAB OF POTTING COMPOST FOR GROWING PLANTS

(75) Inventor: Mathieu Jacobs, Clamart (FR)

Correspondence Address: YOUNG & THOMPSON, 209 Madison Street, Suite 500, Alexandria, VA, 22314, US

(73) Assignee: VERTILIGNES, Paris (FR)

(21) Appl. No.: 12/681,810

(22) PCT Filed: Oct. 7, 2008
(86) PCT No.: PCT/FR08/01400

§ 371 Date: Apr. 6, 2010

(30) Foreign Application Priority Data
Oct. 8, 2007 (FR) 0707050

(51) Int. Cl. A01G 9/02; A01G 1/00

(52) U.S. Cl. 47/65.8

(57) ABSTRACT

Slab of potting compost for creating living walls or planted roofs characterized in that it includes an inextensile sheet equipped with elements for making it permeable to water and to air, an extensile fabric made up of fibres, spaced apart, a potting compost in which plants can be grown, in that the fabric is bonded to one face of the sheet, in that the spaces between the fibres are filled with the potting compost and in that a binder capable of encouraging the formation of clumps of compost, of a size larger than the spaces between the fibres, is mixed in with the compost.

The invention relates to the creation of plant walls or living roofs, i.e., the creation of a substrate that is covered with plants, pitched relative to the horizontal, at an angle that can assume a random value of between 0° and 180° and in particular a vertical plant wall, pitched at 90°.

One way of creating such a wall consists in attaching to the pitched surface a substrate, a slab of potting compost, i.e., a volume of a medium that is capable of the development of plants, whose lateral dimensions, length and width, are clearly greater than the thickness, and then in cultivating plants in the potting compost of the slab and ensuring in particular an adequate water supply for the plants in the slab for encouraging their development beyond this slab.

A problem that is specific to the design of such a slab in pitched use, however, is self-support, i.e., the capacity of the pitched slab to withstand, on a permanent basis, the Earth's gravity and major variations in the moisture in the potting compost, imposed by the spraying and consumption of water that is indispensable to the growth of plants.

For a slab of potting compost, two mechanical actions that are linked to the moisture can actually be anticipated: the cracking or macroscopic embrittlement by solidification of the potting compost in rootballs and the gullying or microscopic embrittlement by dilution of the potting compost in water in the form of mud and its transport by flow.

In the case of a slab that is horizontal and that has a limited thickness, the microscopic and macroscopic embrittlement already work to reduce the service life of the slab by fragmenting it into rootballs of smaller and smaller size by gullying toward the depth of the slab.

For a pitched slab, this effect is amplified to the extent that the pitch angle of the slab increases. Gravity thus brings about a flow of mud by surface gullying, which accelerates the destruction of the potting compost membrane that constitutes the slab by expanding its crevices. It is thus known that the expansion of the pitch angle of a surface that can be cultivated increases the difficulty of cultivating plants there. For a pitched slab, gravity and the moisture variations therefore make it possible to anticipate, in the prior art, a rapid aging that does not make it possible to envision the cultivation of plants on walls without the risk of failure.

The fractionation of the slab into smaller and smaller rootballs of potting compost therefore does not seem be very controllable, primarily on the outside.

To prevent the rootballs from dropping along a moderate slope, the prior art usually proposes a netting- or string-bag-type solution that is arranged on the surface of the slab and that flattens the rootballs on the substrate of the slab to keep them in place. However, for pitched slabs, this solution is powerless to counteract the action of gravity combined with the microscopic embrittlement that causes a rapid gullying of the potting compost along the slab. As soon as the meshes of the string bag become larger than the size of the rootballs, the destruction of the slab cannot be prevented, primarily for large pitch angles or strong spraying.

The destruction of a pitched slab of potting compost is therefore inevitably caused by the combination of cracking and gullying, exacerbated by gravity, and, especially in the case of outside walls, by exposure to bad weather, rain, wind or hail, which accelerate the degradation of the slab. In the prior art, a solution that therefore does not simultaneously resolve the problems of cracking and gullying of the slabs of potting compost therefore does not seem feasible for a pitched use and even less for use outside of these slabs.

Furthermore, for horizontal applications, the prior art knows potting composts that are improved by adding a binder, i.e., a glue that is compatible with the growth of plants that makes it possible to aggregate even moist potting compost in the form of an adequately mechanically resistant rootball to make it possible to handle young plants by the stem without breaking up the rootball that surrounds their root system. These potting composts are, for example, the “preforma” potting compost of the “Jiffy International” Company (http://jiffypot.com). This type of potting compost is used in rootballs. Its mechanical resistance does not make it possible, however, to create rootballs of more than several centimeters in diameter without causing the cracking of the rootball and its breakdown into rootballs of smaller size in the manner of conventional potting compost. The handling of such a rootball for creating a plant wall is therefore even more difficult and subject to causing breaks in the rootball as the latter's surface area increases. Storage in rolled form cannot be considered, for example, and the attachment of a rootball of this type to a substrate is problematical in terms of breakage of the rootball. Such potting compost therefore is not able to simultaneously resolve the cracking and gullying problems for the creation of a slab that is capable of a pitched application for the creation of a plant wall.

The prior art also knows three-dimensional fabrics of fibers that are spaced apart: the product “Teracro” of Terageos (http://www.terageos.com) or “Enkamat” of the “Colbond” Company (http://www.colbond-geosynthetics.fr) may be cited.

This type of fabric is essentially deformable in all directions and designed to accommodate soil on the fibers that compose it and then to be fixed on pitch angles, with numerous restrictions on its use. It is emphasized in particular by the manufacturer himself, for a product such as “Teracro,” that the system does not apply to pitch angles beyond 45°, that the quality of the soil that is used should be suitable, fairly coarse, and that a surface string bag can be used. Potting compost thus is not adapted to use on pitched surfaces with three-dimensional fabrics. It is thus commonly admitted in the prior art that even below a pitch angle of 45 degrees, the three-dimensional fabrics are marred by significant, unresolved defects. These fabrics therefore cannot be envisioned in the prior art as being capable of simultaneously resolving the problems of cracking and gullying of pitched slabs of potting compost, in particular exposed to rain, wind, and hail.

The problem of creating a self-supporting slab of potting compost, with lateral dimensions of more than one decimeter, for the growth of plants on walls therefore does not seem settled upon in the prior art, in particular on the outside of buildings and in the presence of bad weather. In this context, the invention is defined as follows:
1) Slab of potting compost for the creation of plant walls or living roofs, characterized in that it comprises an inelastic sheet that is equipped with means for making it permeable to water and air, an elastic fabric that consists of fibers, spaced apart, potting compost, capable of making plants grow, in that the fabric is glued to a surface of the sheet, in that the spaces between the fibers are filled with the potting compost, and in that a binder that can allow the formation of rootballs of potting compost, of a size that is larger than the spaces between the fibers, is mixed with the potting compost.
2) Slab according to 1), wherein the binder is a bitumen.
3) Slab according to 1), wherein the binder is rubber or latex.
4) Slab according to 1), wherein the binder is an animal gelatin or an alimentary glue.
5) Slab according to 1) to 4), wherein the means for making the sheet permeable to water and to air consist of the porosity of the sheet.
6) Slab according to 1) to 4), wherein the means for making the sheet permeable to water and to air consist of at least one hole that is pierced in the sheet.
7) Process for the creation of a slab of potting compost according to 1) to 6), wherein it comprises the following stages: mixing the potting compost with water and with a binder that is water-soluble and polymerizable by elimination of water to obtain a mud, depositing the mud that is obtained on a fabric of fibers that are spaced apart and glued to the surface of a sheet that is permeable to water and to air, whereby the fabric is located between the intake of the mud and the sheet, allowing the mud to invade the spaces between the fibers and to eliminate the air and water to obtain potting compost that is bonded in rootballs of a size that is larger than the spaces between the fibers.
8) Application of the slab of potting compost according to 1) to 6), obtained according to 7), to the creation of plant walls on a roof-type pitched substrate by attaching the slab to the substrate and by cultivating plants that are inserted into the slab.

### DESCRIPTION OF THE INVENTION

The invention is described below for a particular mode that uses a three-dimensional fabric that comprises spaced fibers, named “Enkamat” of the “Colbond” Company, and a potting compost that is mixed with a binder that is manufactured by the “Jiffy” Company under the name “Preforma.” A potting compost of this type is also described in the Canadian Patent No. 1046281 entitled “Growth Medium for the Cultivation of Plants” and granted to Jiffy Products International Ltd.

In this type of potting compost, the binder is a bitumen, dispersed in aqueous emulsion and then deposited on the fibers of the potting compost by elimination of water. Rootballs that are 3 mm to 10 mm in size that preserve their shape under spraying can be created with peat according to the teaching of this patent. For the implementation of the invention, a mixture of loam and peat or potting compost, resulting in different rootball sizes, can also be used.

Likewise, rubber that is dissolved in an aqueous solution or animal gelatin that is dissolved in water could be used instead of the bitumen emulsion.

Interlaced, rot-proof plastic threads or else glass wool could be used as fibers for the creation of three-dimensional fabrics.

For this particular mode of the invention, the three-dimensional fabric is glued to the surface of a so-called “non-woven,” inelastic sheet. This sheet is porous and permeable to air and water, and holes are made in the sheet to allow the rapid evacuation of water and air during the creation of the slab. The fabric that is glued to the sheet is thus not elastic in a direction that is parallel to the surface of the sheet.

The potting compost that is used with its binder has the property of neither breaking up nor changing shape during spraying in horizontal position and making it possible to transport a young plant with a rootball of potting compost mixed with binder that surrounds its roots, even moist. It also has the property of being able to be made liquid by adding water before polymerization of the binder and then is resistant to water by evacuation and evaporation of the water that brings about the polymerization of the binder.

Within this context, the potting compost that comprises the binder is mixed with water to make it liquid or muddy. It is then deposited on the fabric that rests on the sheet and, by gravity, expels the imprisoned air, between the mud and the sheet, into the fabric, by means of the porosity and holes of the sheet as well as by flow via the edges of the sheet, to completely fill the gaps of the fabric with the mixture of potting compost and binder.

Through evacuation of water and drying, the mud is transformed into bonded potting compost and surrounds the fibers of the fabric by forming, owing to the polymerization of the binder, rootballs of lateral dimensions that are greater than the free spaces between the fibers. In this way, during drying, the water can remain trapped in the spongy potting compost, available to the plants, for an immediate use of the slabs, or the water can be completely eliminated for distribution of the slabs and a different usage, in the manner of a construction material. The binder is selected to impose the shaping of rootballs whose size is greater than the free spaces between the fibers of the fabric, regardless of the degree of moisture, so as to make it possible to hold these rootballs that surround the fibers of the fabric by the fabric.

Such a binder does not have the constraints of durability of a glue for the application under consideration, and the invention is not limited to the type of potting compost that is mentioned under the name “Preforma”; actually, the development of the plant root system in use subjected to rain and wind takes over the binder over time, to incorporate the bonded potting compost and to limit the cracking phenomenon effects. Likewise, the stems and leaves of growing plants also gradually prevent the direct spraying of the potting compost, limiting the gullying phenomenon. The characteristics of the binder can therefore be selected from existing glues that swell greatly with water, a first solubility in water, and a first polymerization that is the most complete possible by elimination of water, in particular by flow or evaporation, a general non-toxicity with regard to plants, and a water resistance after polymerization that is on the order of the period of growth of the roots of the plants that are to be planted subsequently in the potting compost.

A concentration of 1% to 2% by weight of bitumen in the total weight of the mixture of bitumen with potting compost is in general adapted for obtaining the effect of the invention. This concentration, however, can be adapted experimentally based on the available fabric, the potting compost that is used, and the binder that is selected. A satisfactory concentration of binder for a given fabric can actually be determined by observing the distance between the cracks of the potting compost that is mixed with binder, after drying, by measuring the size of the free spaces between the fibers of the fabric and by selecting a binder concentration that provides a minimum distance between cracks, greater than the mean dimension of the free spaces. When the cracks do not form closed curves of rootballs, the binder concentration can also be determined by selecting a binder concentration that provides a greater crack length than the free spaces between the fibers. In these particular cases, the size of the rootball is quite larger than the free spaces between fibers, and the binder concentration can be optimized on other criteria, such as the speed of penetration of the potting compost and binder in the fabric. When the size of the rootballs is comparable to the free space between the fibers of the fabric, it is possible to choose to exchange the fabric for tighter fibers or to vary the binder concentration to increase the minimum size of the rootballs.

The sheet of the invention is selected to be inelastic to avoid additional cracking of the rootballs that would take place by expansion of the fabric that they fill. The sheet is more preferably porous and equipped with holes. The porosity of the sheet or the presence of holes in the sheet can be taken into consideration separately for the production of the invention; their simultaneous use is preferable, however, for allowing both a certain retention of water by the adjustment of the porosity of the sheet and an evacuation of air through the holes of this sheet during the introduction of the potting compost that is mixed with binder, in the form of liquefied mud, in the fabric.

In this context, a process for production of the invention consists of, for example, the following stages: gluing the fabric on the sheet, mixing the potting compost with the non-polymerized binder and with water to obtain a liquid mud, placing the sheet on a substrate that makes it possible to evacuate the water and the air via the holes of the sheet, whereby the sheet separates the fabric from the substrate, depositing by gravity the mud on the fabric, whereby the fabric separates the intake of mud from the sheet, supplying mud until having expelled the air from the fabric via the holes and the porosity of the sheet, and letting the potting compost dry with the binder in the gaps or free spaces of the fabric.

In an industrial production of slabs of potting compost according to the invention and of great length, a nozzle deposits the potting compost and the binder in aqueous solution, in the form of mud, on a strip of fabric that is glued to a sheet that passes under the nozzle. In this case, the presence of holes in the sheet makes it possible to achieve the complete filling of fabric for a faster travel speed of the fabric past the nozzle, with given mud viscosity and fluidity, than in the absence of holes. The presence of holes is therefore an advantage for the process of production of the invention.

Slabs according to the invention are adapted to the creation of plant walls on substrates of various pitch angles by attaching slabs to the substrates and cultivation of plants inserted into the slabs.

The invention is conducive to the industrial application within the field of the creation of plant walls or plant roofs that are pitched or horizontal.

1. Slab of potting compost for the creation of plant walls or living roofs, characterized in that it comprises an inelastic sheet that is equipped with means for making it permeable to water and air, an elastic fabric that consists of fibers, spaced apart, potting compost, capable of making plants grow, in that the fabric is glued to a surface of the sheet, in that the spaces between the fibers are filled with the potting compost, and in that a binder that can allow the formation of rootballs of potting compost, of a size that is larger than the spaces between the fibers, is mixed with the potting compost.

2. Slab according to claim 1, wherein the binder is a bitumen.

3. Slab according to claim 1, wherein the binder is rubber.

4. Slab according to claim 1, wherein the binder is an animal gelatin.

5. Slab according to claim 1, wherein the means for making the sheet permeable to water and to air consist of the porosity of the sheet.

6. Slab according to claim 1, wherein the means for making the sheet permeable to water and to air consist of at least one hole that is pierced in the sheet.

7. Process for the creation of a slab of potting compost according to claim 1, wherein it comprises the following stages: mixing the potting compost with water and with a binder that is water-soluble and polymerizable by elimination of water to obtain a mud, depositing the mud that is obtained on a fabric of fibers that are spaced apart and glued to the surface of a sheet that is permeable to water and to air, whereby the fabric is located between the intake of the mud and the sheet, allowing the mud to invade the spaces between the fibers and to eliminate the air and water to obtain potting compost that is bonded in rootballs of a size that is larger than the spaces between the fibers.

8. Method of creating plant walls on a roof-type pitched substrate, which comprises: attaching the slab of potting compost of claim 1 to the substrate and cultivating plants that are inserted into the slab.
